(19) United States
(12) Patent Application Publication
(10) Pub. No.: US 2015/0185029 A1
(43) Pub. Date: Jul. 2, 2015

(54) MAP VERSION SYNCHRONIZATION PATH SEARCH METHOD

(71) Applicant: HYUNDAI MOTOR COMPANY, Seoul (KR)

(72) Inventor: Chang-Soo KIM, Yongin-shi (KR)

(21) Appl. No.: 14/547,016

(22) Filed: Nov. 18, 2014

(30) Foreign Application Priority Data
Dec. 31, 2013 (KR) 10-2013-168002

(51) Int. Cl. G01C 21/34; G01C 21/36

(52) U.S. Cl. CPC G01C 21/34; G01C 21/3697

(57) ABSTRACT

A map version synchronization route searching method includes transmitting, by a terminal disposed in a vehicle, destination route searching request information and map version information of the terminal to a center server. The center server searches a map having a same version as indicated by the map version information transmitted by the terminal. A route corresponding to the destination route searching request information transmitted by the terminal is searched for using the map having the same version as indicated by the map version information. The route which is searched for by the center server is transmitted to the terminal. The terminal performs a route guidance.

### CROSS-REFERENCE TO RELATED APPLICATION

This application claims benefit of priority to Korean Patent Application No. 10-2013-168002, filed on Dec. 31, 2013, in the Korean Intellectual Property Office, the entire content of which is incorporated herein by reference.

### TECHNICAL FIELD

The present inventive concept relates to a route searching technology using a car navigation system and more particularly, to a map version synchronization route searching method which allows a center server to search a route using a map with the same version as map version information of a terminal by additionally transmitting the map version information of the terminal when the terminal requests the center server to search a route.

### BACKGROUND

Recently, a car navigation service which searches an optimal route from a current location to a destination when a driver inputs information of the destination to provide the searched route to the driver through an image and/or audio is widely used.

The car navigation service is provided by a car navigation system in which various sensors such as a global positioning system sensor, a speed sensor, and a gyro sensor are mounted. There are two methods to provide the navigation service, including a first method of searching and providing a route directly by the terminal when a driver inputs information on a current location or a destination using the car navigation system and a second method in which the terminal requests a center server to search a route to receive the searched route from the center server.

Between the two methods, a quality of information provided by the second method which receives the searched route from the center server is better than a quality of information provided by the first method which searches the route by the terminal because the second method may reflect recent traffic information and use a high performance server for multiple search.

However, when a map version which is used to search a route by the center server is different from a map version of the current terminal, according to the second method which receives the searched route from the center server, it is difficult to entirely drive the route which is provided from the center server and the terminal needs to search an additional route to be used if necessary.

Therefore, problems caused by the difference between the map version of the center server which searches the route and that of the terminal which receives the route information need to be acutely solved.

### SUMMARY

The present inventive concept has been made in an effort to provide to a car navigation system a map version synchronization route searching method which applies and uses route information which is searched by a center server and has a better quality than a quality of route information searched by the terminal.

The present inventive concept has also been made in an effort to provide a map version synchronization route searching method in which a terminal in a car navigation system has a link weight and which is not required to search the route one more time so that unnecessary cost and wasted energy may be prevented.

Technical objects to be achieved in the present inventive concept are not limited to the aforementioned technical objects, and other not-mentioned technical objects will be obviously understood by those skilled in the art from the description below.

One aspect of the present inventive concept relates to a map version synchronization route searching method, including transmitting, by a terminal disposed in a vehicle, destination route searching request information and map version information of the terminal to a center server. The center server searches a map having the same version as indicated by the map version information transmitted by the terminal. A route corresponding to the destination route searching request information transmitted by the terminal is searched for using the map having the same version as indicated by the map version information. The route searched for by the center server is transmitted to the terminal. The terminal performs a route guidance.

The destination route searching request information of the terminal may include at least one of information on a shortest route from a current location to a destination, information on a route with a shortest time from the current location to the destination, information on a route using only a freeway from the current location to the destination, and information on a route which preferentially searches an expressway, a highway, or a motorway from the current location to the destination.

The method may further include after the performing, by the terminal, the route guidance, the terminal displays a message of updating a map version when the map version transmitted to the center server by the terminal is not a latest version.

The method may further include after the transmitting of the route searched for by the center server to the terminal, storing and managing, by the center server, the map version of the terminal in a database when the map version transmitted to the center server by the terminal is not the latest version.

In the performing of the route guidance, information may be selected from among the route transmitted to the terminal.

The method may further include maintaining a latest map version in the center server.

In the searching for the route, the route may be searched for using information on a current location of the vehicle, information on a moving direction of the vehicle, road information, and traffic information.

According to the present inventive concept, the center server recognizes map version information of a terminal which is currently applied in a vehicle and reflects the map version information to search a route so that the terminal does not need to separately search a route due to inconsistency of the route or the map.

Route information which is searched by the center server has better quality and precision than that of the route information which is searched in the terminal so that convenience of driving to the destination is improved.

### BRIEF DESCRIPTION OF THE DRAWINGS

FIG. 1 is a diagram of a map version synchronization route searching system according to an exemplary embodiment of the present inventive concept.

FIG. 2 is a flowchart of a map version synchronization route searching method according to an exemplary embodiment of the present inventive concept.

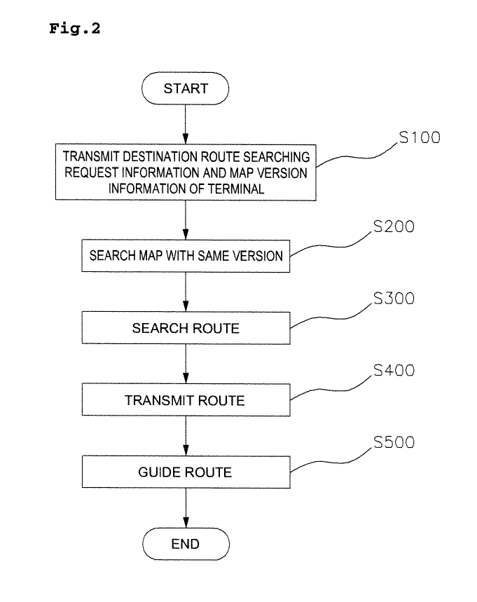

### DETAILED DESCRIPTION

Hereinafter, exemplary embodiments of the present inventive concept will be described in detail with reference to the accompanying drawings. Prior to this, terms or words used in the specification and the claims should not be restrictively analyzed as a general and dictionary meaning and should be analyzed as having a meaning and a concept which conform to the technical spirit of the present inventive concept based on a principle that the inventor can appropriately define a concept of a term in order to describe his/her own inventive concept by the best manner. The embodiments described in the present specification and configurations illustrated in the drawings do not represent all of the technical spirit of the present inventive concept, and thus it is to be understood that various equivalents and modified examples, which may replace the embodiments, are possible when filing the present application.

An exemplary embodiment of the present inventive concept may synchronize a version of a map which is used to search a route by a center server with a map version of a terminal which is currently mounted in a vehicle so that no additional route search is required in the terminal. A method according to an exemplary embodiment of the present inventive concept may include a step of transmitting, by a terminal 100 mounted in the vehicle, destination route searching request information and map version information of the terminal to a center server 200, a step of searching, by the center server, a map having the same version as the map version information which is transmitted by the terminal, a step of searching a route corresponding to the destination route searching request information transmitted by the terminal using the map which is searched by the center server, a step of transmitting the route which is searched by the center server to the terminal, and a step of performing, by the terminal, route guidance.

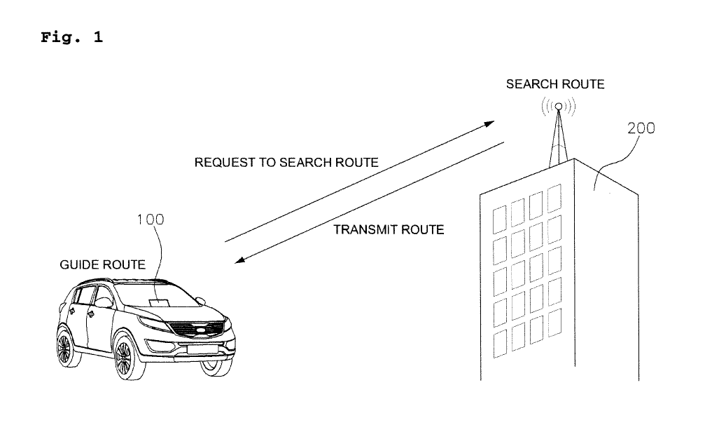

FIG. 1 illustrates a diagram of a map version synchronization route searching system according to an exemplary embodiment of the present inventive concept and FIG. illustrates a flowchart of a map version synchronization route searching method according to an exemplary embodiment of the present inventive concept.

Now, a map version synchronization route searching procedure will be described. First, a terminal 100 which is provided in a vehicle may transmit to a center server 200 destination route searching request information and map version information of the terminal in step S100.

The terminal 100 may be a device which performs a function of searching a route to the destination and include any devices that can perform the above-mentioned searching function in addition to a car navigation system or a navigation system, which represent the terminal.

The center server 200 may be a system which provides a service of receiving a route searching request from the terminal 100 to directly search an optimal route and then transmitting a result of the search to the terminal. The service may be a free service or a charged service.

For example, Hyundai Motor Group provides an optimal route service called “Blue link”™ or “UVO”™ such that a center server of the service always maintains a map with the latest version.

In the meantime, the destination route searching request information which is transmitted to the center server 200 by the terminal 100 may include at least one of information on the shortest route from the current location to the destination, information on a route with a shortest time from the current location to the destination, information on a route using only a freeway from the current location to the destination, and information on a route which preferentially searches an expressway, a highway, or a motorway from the current location to the destination.

If necessary, the terminal 100 may transmit all the above information to the center server 200 and receive a result thereof from the center server to provide the result to a driver. Accordingly, the driver may select necessary information from among the result to perform route guidance.

The center server 200 may search, in step S200, a map having the same version as map version information which is transmitted from the terminal 100.

The map version of the center server 200 may be always generally maintained as the latest version. Therefore, when the map version of the terminal 100 is the latest version which is the same as the map version of the center server, there is no big problem.

However, when the map version of the terminal 100 is not the latest version, the center server 200 may search the map version in a database to search a route using a map having the same version as the version of the terminal 100.

To this end, even when the center server 200 upgrades a version of the map, the center server 200 may leave an existing map version in a specific database space. The center server 200 may search, in step S300, a route corresponding to destination route searching request information which is transmitted by the terminal 100 using a searched map.

A route searching method may be a method which searches a route using information on a current location of the vehicle, information on a moving direction of the vehicle, road information, and traffic information. When an optimal route to the destination is successfully searched, the center server 200 may transmit the searched route to the terminal 100 in step S400.

When the version of the map which is transmitted by the terminal 100 is not a latest version, the center server 200 may separately store the map version of the terminal 100 in the database to collectively manage the map version so as to collectively notify the user of the terminal 100 when it is necessary to upgrade the map version later.

As a result, the terminal 100 may perform, in step S500, route guidance using the route which is transmitted from the center server 200 and the route guidance may be supported by an image and/or an audio.

Additionally, when the map version of the terminal 100 is not the latest version, the terminal 100 may display a message for updating the map version so as to notify the user that the current map version of the terminal is not the latest version.

Therefore, whenever a user or a driver of the vehicle searches a route using the terminal 100, the user or the driver may notice, e.g., receive a notification, when it is necessary to upgrade the map version of the terminal.

According to an exemplary embodiment of the present inventive concept, the center server 200 may search a route using a map with the same version as the map version of the terminal 100 which is currently applied to the vehicle, so that inconvenience of separately searching a route by the terminal due to a difference of map versions may be removed.

According to an exemplary embodiment of the present inventive concept, the route information which is searched in the center server may have better precision and quality than those of the route information which is searched in the terminal 100 so that convenience of driving to the destination is improved.

As described above, the present inventive concept has been described in relation to specific embodiments of the present inventive concept, but the embodiments are only illustration and the present inventive concept is not limited thereto. Embodiments described may be changed or modified by those skilled in the art to which the present inventive concept pertains without departing from the scope of the present inventive concept, and various alterations and modifications are possible within the technical spirit of the present inventive concept and the equivalent scope of the claims which will be described below.

What is claimed is:

1. A map version synchronization route searching method, comprising:
transmitting, by a terminal disposed in a vehicle, destination route searching request information and map version information of the terminal to a center server;
searching, by the center server, a map having a same version as indicated by the map version information transmitted by the terminal;
searching for a route corresponding to the destination route searching request information transmitted by the terminal, using the map having the same version as indicated by the map version information;
transmitting, to the terminal, the route which is searched for by the center server; and
performing, by the terminal, a route guidance.

2. The method of claim 1, wherein the destination route searching request information of the terminal includes at least one of information on a shortest route from a current location to a destination, information on a route with a shortest time from the current location to the destination, information on a route using only a freeway from the current location to the destination, and information on a route which preferentially searches an expressway, a highway, or a motorway from the current location to the destination.

3. The method of claim 1, further comprising:
after the performing, by the terminal, the route guidance, displaying, by the terminal, a message of updating a map version when the map version transmitted to the center server by the terminal is not a latest version.

4. The method of claim 1, further comprising:
after the transmitting of the route searched for by the center server to the terminal, storing and managing, by the center server, the map version of the terminal in a database when the map version transmitted to the center server by the terminal is not a latest version.

5. The method of claim 1, wherein the performing of the route guidance including selecting information from among the route transmitted to the terminal.

6. The method of claim 1, further comprising maintaining the latest map version in the center server.

7. The method of claim 1, wherein the searching for the route includes searching for the route using information on a current location of the vehicle, information on a moving direction of the vehicle, road information, and traffic information.
